(19) United States
(12) Patent Application Publication
(10) Pub. No.: US 2008/0249965 A1
(43) Pub. Date: Oct. 9, 2008

(54) System and Apparatus for Collecting and Distributing Voluntary Environmental Impact Offset Payments on Fuel Purchases at Point of Sale

(75) Inventors: Seth B. Pollack, Seattle, WA (US); David L. Kaplan, Seattle, WA (US); Seth W. Bridges, Seattle, WA (US)

Correspondence Address: LEE & HAYES, PLLC, 421 W. RIVERSIDE AVE, STE 500, SPOKANE, WA, 99201, US

(73) Assignee: V2Green, Inc., Seattle, WA (US)

(21) Appl. No.: 12/049,227

(22) Filed: Mar. 14, 2008

Related U.S. Application Data
(60) Provisional application No. 60/894,813, filed on Mar. 14, 2007.

(51) Int. Cl. G06F 17/00

(52) U.S. Cl. 705/413

(57) ABSTRACT

Systems and methods are described for collecting and distributing environmental impact offset payments at the point of sale of a fuel. An exemplary method presents a user interface at a point of sale of a purchase of a fuel, receives via the user interface a user-selection indicating an intention of the user to pay an environmental impact offset fee associated with the purchase, presents a choice to the user of making a custom offset payment or of buying a fuel that has the offset fee included in the price of the fuel, and calculates a custom offset payment for the purchase. The custom offset payment can be based on such considerations as an energy equivalency of the fuel purchased, volume or weight of the fuel being purchased, fuel type, fuel grade, e.g., octane level, oxygenation level, temperature of the fuel, fuel composition, climatic data, regional variation in fuel composition, efficiency of a vehicle receiving the fuel, pollution control capability of the vehicle receiving the fuel, and life-cycle environmental impacts of fuels, such as costs for extraction, processing, delivery, and combustion.

### RELATED APPLICATIONS

This patent application claims priority to U.S. Provisional Patent Application No. 60/894,813 to Pollack et al., entitled, “System and Apparatus for Collecting and Distributing Voluntary Environmental Impact Offset Payments on Fuel Purchases at Point of Sale,” filed Mar. 14, 2007 and incorporated herein by reference.

### BACKGROUND

Fossil fuels such as gasoline and petroleum diesel have substantial negative environmental effects, including:
Release of greenhouse gases, such as carbon dioxide (CO₂), which disrupt the global climate, often with destructive side effects.
Release of pollutants toxic to humans or other life, such as sulfur dioxide (SOx), nitrous oxide (NOx), lead, and particulates.
Use of scarce natural resources, such as water, land, etc. in the extraction, production, distribution, or consumption of the fuel.

These negative effects are caused by providing the product (creating the product, transporting it, distributing it or otherwise making it available for sale), and by using the product for its intended purpose (for example, burning it in an internal combustion engine).

Production and use of petroleum fuels account for a large share of all greenhouse gas emissions in the United States. Much of the negative impact is created by burning petroleum products (e.g., while driving), but significant amounts of greenhouse gases are also produced by drilling, refining, and transporting the fuel.

What is needed is a way to fairly offset the negative environmental impacts of environmental impacts of gasoline, diesel, bio-diesel, ethanol, fuel blends, electricity, hydrogen, propane, natural gas, aviation fuel, fuel oil, coal, wood, or other forms of energy, including greenhouse gases (CO₂), air pollution (particulates, SOx, NOx, lead), and use of scarce natural resources (water, land area, forests); and to offset the environmental impacts resulting from production, distribution, consumption, or other phases of a fuel's life-cycle.

Limitations of Existing Methods

Some related services exist. For example, there are website services where one may self-report key environmental impact activities, such as driving, flying, and home energy use, typically to estimate greenhouse gas generation. However, this method is limited in several ways, including:
These services are not known to many people.
The services are not easy to use; the user must remember to visit the website periodically, and enter facts such as how many miles driven, etc.
The services are not accurate; generally these services estimate items such as gallons of fuel used, environmental impact of the fuel, etc.
The services are not immediate; that is, they are not available at the time and point of sale.

### BRIEF DESCRIPTION OF THE DRAWING

FIG. 1 is a flow diagram of an exemplary method of calculating a custom environmental impact offset fee associated with sale or purchase of a fuel.

### DETAILED DESCRIPTION

### Overview

This disclosure describes methods, systems, and apparatuses for automatically calculating a custom offset fee that purchasers may voluntarily pay to offset the negative environmental impacts of the fuel they purchase, at the time and point of sale.

This invention overcomes the limitations of existing approaches by integrating the collection of an optional, voluntary environmental impact offset fee within the fuel purchase transaction. In one implementation, the impact offset fee is automatically and dynamically calculated. Many consumers want to decrease their carbon dioxide footprint, e.g., as demonstrated by increasing sales of hybrid cars, but have little choice for their transportation except to use fossil fuels, and little or no familiarity with conventional offset methods. The invention thus offers a mechanism for fulfilling a substantial unmet consumer demand.

The offset payment can be collected in a variety of ways. The offset payment can be collected in one of two ways: either as a separate line item in the fuel purchase transaction, or as an embedded portion of the fuel product price.

Consider, for example, how each of these payment collection mechanisms relates to the process of buying gasoline. In one scenario, after completing the fuel transfer, the consumer is asked whether they would like to pay the environmental offset fee for the fuel purchased. In a second scenario, the consumer is offered an identifiably different fuel product, such as “green unleaded gasoline”, with the environmental offset fee built in. In this manner, the customer is presented with a choice at the time of purchase. The consumer does not have to know about a separate service. They do not have to remember to enter each purchase into a separate service. They do not have to remember the quantity or exact product type of each purchase.

In one implementation, the offset payment is calculated in real time based upon specific temporal, spatial, or climatic factors that may affect the pollution characteristics of the fuel being purchased.

The exemplary system also includes a new mechanism to address another limitation inherent in the fuel supply chain. In the United States and many other countries, most refueling service stations are branded with the names of oil refining and marketing companies. Hence, consumers typically believe that their payment at such stations accrues primarily to an oil company. Oil companies have a negative reputation with many consumers, especially on issues related to climate disruption and global warming. These factors suggest that a point-of-sale offset system such as the present invention could fail to attract voluntary payments from skeptical consumers who believe that their money will contribute to oil company profits, rather than being applied to pollution offsets.

To address this limitation, the exemplary system includes consumer-accessible information and communication features that ensure transparency and accountability in the way offset payments are collected and disbursed. The invention can also be deployed, labeled and branded by an independent system operator to establish the system's independence from oil refining and marketing companies or other suspect entities.

The offset payments are then used in a variety of ways, including reducing greenhouse gases, pollutants, etc. generated elsewhere to compensate for the environmental impact caused by the subject product. For example, carbon dioxide caused by the product might be offset by using the payment to help capture methane (an even more potent greenhouse gas) that otherwise would be released into the atmosphere. The payment could also be used to create efficiency programs that reduce the use of energy that would otherwise result in greenhouse gases being released. The payment can also be used to create new energy sources (such as wind or solar power installations) with little or no greenhouse gas impact.

Exemplary System

An example system includes a user interface at the point of fuel sale that offers the consumer (“user”) several options. First, the system offers the user a choice of whether to participate in voluntary offset payments at the current purchase, or not. The system may also have the capability of offering user account creation, and in a distributed context, maintaining the user account across purchases at other times and locations.

The point-of-sale user interface may, for example, be implemented via an existing automated point-of-sale machine (e.g., self-pay vehicle fuel dispenser), wherein the system offers a user-experience similar to buying an add-on car wash with a fuel purchase.

Next, the system may offer the user a second choice of making an offset payment by adding an offset surcharge to the fuel product's price, or by offering a version of the fuel product with the offset surcharge included in the price. In various implementations, the system accepts payment via cash, credit card or pre-paid environmental offset points; and in-person (e.g., to a salesperson) or via an automated payment machine.

Next, the exemplary system and point-of-sale user interface may allow the user to accept or reject a system-calculated custom offset payment; or to specify, or select within a system-calculated range of options, an offset payment of the user's choice.

The point-of-sale user interface lets the user establish an optional user account, which may also be established by other means (web signup, printed form, etc.). In one embodiment, the consumer receives a printed receipt at the point of sale containing a transaction ID; the ID can be entered later in a web signup form to create an account linked to the consumer's original purchase. The account can track additional considerations related to offset payments, such as tax deductibility.

When a user account is established at point of sale, the system can, with the user's permission, securely use information such as the user's credit card number to access user contact information (e.g., email address, postal address or phone number); or, with the user's permission, collect such user contact information via prompting.

The user may access their account away from the point of sale, via a web site or similar mechanism maintained by the system. The user account enables, for example, user-specified allocation of offset payments to chosen investments; user access to purchase history, past offset payments, etc.

Custom Offset Engine

The exemplary system provides a custom offset engine for calculating the costs of the environmental impacts of a specific fuel purchase. In one implementation, calculations are performed in separate software modules running simultaneously on a point-of-sale terminal where the fuel is purchased and a network-accessible data center that houses a central database, communicating via a reliable, high-bandwidth, highly-available network connection. The terminal and the data center each have one or more computing devices consisting of processors, memory, data storage, etc.

In one implementation, the custom offset engine calculates a custom offset payment or debit in real time based on actual temporal, spatial, climatic or usage factors such as fuel type, fuel grade, octane level, oxygenation level (often seasonally-adjusted), temperature, regional variations in fuel composition, pollution control capability of the vehicle receiving the fuel, etc.

The custom offset engine may receive input data from an automatic detection mechanism (e.g., a device that performs and reports chemical analysis on the fuel being dispensed) and/or via user input (e.g., a consumer entering a vehicle identification number); or the engine may generate input from database lookups or internal calculations based, for example, on canonical, average or expected values for fuel characteristics and system parameters.

The custom offset engine includes stored information and associated procedures for quantifying the chemical, physical and energy content of fuels, life-cycle environmental impacts of fuels (current values of extraction, processing, delivery, combustion costs) and, where applicable, life-cycle environmental benefits of fuels (e.g., renewable bio-fuels whose replacement crops may sink atmospheric carbon dioxide).

The exemplary system may also provide an automatic mechanism for distributing collected offset fees among possible recipients. For example, in one embodiment, the collected fee is distributed to recipients who invest the money directly in environmentally beneficial offset activities, such as conservation, efficiency, or usage curtailment measures, or sources of clean renewable energy (for example, wind or solar power).

In another implementation, some of the collected fee may be paid as incentive to key actors to participate (for example, station owners, payment processors, or system implementers).

In one implementation, some of the collected offset may be invested directly in environmental offset measures applied to system participants, for example, investments in energy efficiency measures for participating fueling stations.

A fee distribution mechanism permits continuous sliding-scale adjustment of the allocations paid to any or all parties.

The fee distribution mechanism can allocate collected fees based on 1) automatic rule-based mechanisms, such as investing first in those projects with the strongest environmental payback or closest to the user's home location; 2) other automatic mechanisms, for example a ‘crossbar’ mapping that recommends a specific mix of offset measures for a given fuel or fuel blend product, based on the product's pollution characteristics; 3) user input; or 4) a combination of these mechanisms.

The system provides a mechanism for investing in a variety of environmental offset measures, including: market-based instruments such as carbon pollution credits or cap and trade systems for other pollutants; renewable energy credits (RECs); measures aimed at fuel users, such as incentives or subsidies for vehicle tune-ups, switching to cleaner vehicles or using public transportation; direct investments in conservation, curtailment or efficiency; direct investments in greenhouse gas reduction, such as tree planting or methane digesters; and direct investments in clean renewable generation sources.

The system provides a consumer-accessible information and communication mechanism that ensures transparency and accountability in the way offset payments are collected and disbursed. This information is subject to independent third-party audit, and is available online and in printed form to the general public.

The system provides a mechanism for integrating with existing fuel payment systems (e.g., point-of-sale terminals and payment networks). In a preferred embodiment, this mechanism includes a means for implementing the system with no change to existing point-of-sale hardware simply by downloading new software into an existing point-of-sale terminal and implementing the user interface entirely within the hardware capabilities (e.g., screen and keypad) of the existing terminal.

Exemplary Methods

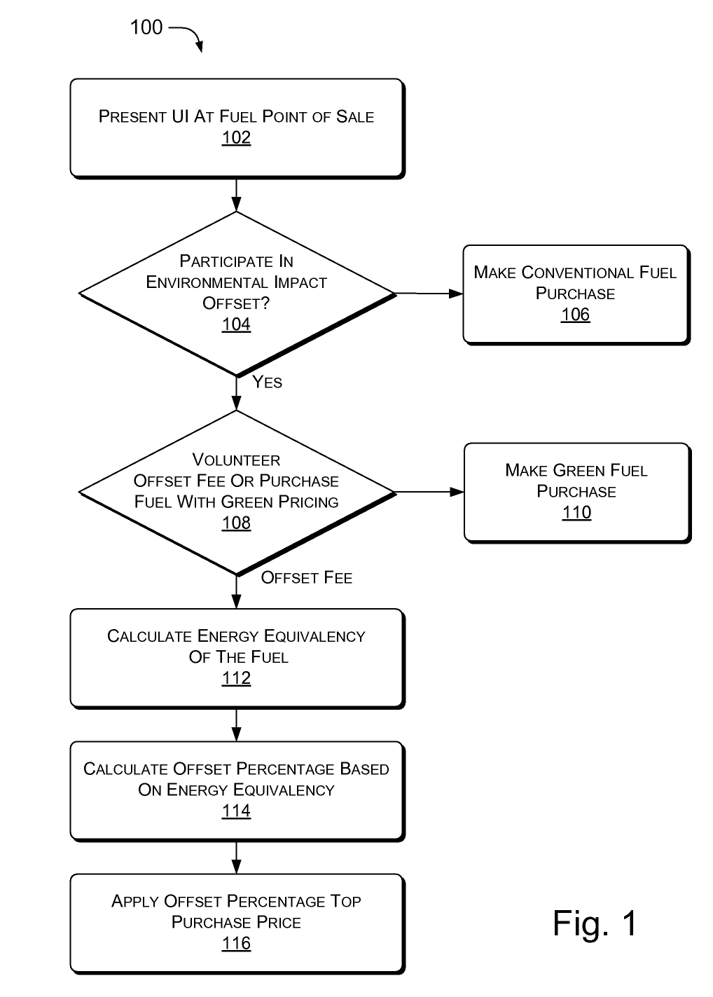

FIG. 1 shows an exemplary method 100 of calculating a custom environmental impact offset fee associated with sale or purchase of a fuel. In the flow diagram, the operations are summarized in individual blocks. The exemplary method 100 may be performed by combinations of hardware, software, firmware, etc.

At block 102, a user interface is presented to a fuel purchaser at the point of sale.

At block 104, the user interface queries whether the user desires to participate in environmental impact offset.

At block 106, when the user does not wish to participate, the user interface enables a conventional fuel purchase.

At block 108, when the user desires to participate, the user interface queries whether the user desires to make a custom offset payment, or rather, purchase a fuel that has an offset fee included in the price of the fuel.

At block 110, when the purchaser desires to purchase the fuel that has the offset fee included, the user interface enables a purchase of such fuel.

At block 112, when the purchaser desires to volunteer an offset payment, the method calculates an energy equivalency of the fuel.

At block 114, the method calculates an offset percentage based on the energy equivalency.

At block 116, the method applies the offset percentage to the purchase price of the fuel to calculate the offset fee.

1. A method, comprising:
presenting a user interface at a point of sale of a purchase of a fuel;
receiving via the user interface a user-selection indicating an intention of the user to pay an environmental impact offset fee associated with the purchase;
presenting a choice to the user via the user interface of making a custom offset payment or of buying a fuel that has the offset fee included in the price of the fuel;
when the user selects paying the custom offset payment, then calculating the custom offset payment, including:
calculating an energy equivalency of the fuel purchased;
calculating an offset percentage for the type of fuel based on the energy equivalency; and
applying the offset percentage to the purchase price of the fuel being purchased.

2. The method as recited in claim 1, wherein the offset fee included in the price of the fuel is custom calculated for the specific fuel.

3. The method as recited in claim 1, wherein calculating the offset percentage is based on one or more of: a volume or weight of the fuel being purchased, a fuel type, a fuel grade, an octane level, an oxygenation level, a temperature of the fuel, a fuel composition, climatic data, a chemical composition of the fuel, a regional variation in fuel composition, an efficiency of a vehicle receiving the fuel, and a pollution control capability of the vehicle receiving the fuel.

4. The method as recited in claim 3, further comprising receiving input data from an automatic detection device that performs and reports chemical analysis on the fuel.

5. The method as recited in claim 3, further comprising receiving input data from user input of a vehicle identification number or a user account.

6. The method as recited in claim 3, further comprising generating data for the offset percentage from a database lookup or internal calculations based on canonical, average, or expected values for fuel characteristics and system parameters.

7. The method as recited in claim 3, wherein calculating the offset percentage includes calculating a factor for a life-cycle environmental impact of the fuel, including a current value for each of extraction, processing, delivery, and combustion of the fuel.

8. The method as recited in claim 1, further comprising receiving a user selection via the user interface for distributing the offset fees, including an option to distribute to recipients who invest the money directly in environmentally beneficial offset activities, such as clean-up, conservation, efficiency, or usage curtailment measures, or sources of clean renewable energy.

9. An apparatus, comprising:
a processor;
a memory;
a data store;
a logic module including instructions storable in the memory and data store and executable in the processor for calculating an environmental impact offset fee associated with the purchase of a fuel, including:
instructions for calculating an energy equivalency of the fuel purchased;
instructions for calculating an offset percentage for the type of fuel based on the energy equivalency; and
instructions for applying the offset percentage to the purchase price of the fuel being purchased.

10. The apparatus as recited in claim 9, wherein the instructions include logic for calculating the offset percentage based on one or more of: a volume or weight of the fuel being purchased, a fuel type, a fuel grade, an octane level, an oxygenation level, a temperature of the fuel, a fuel composition, climatic data, a chemical composition of the fuel, a regional variation in fuel composition, an efficiency of a vehicle receiving the fuel, and a pollution control capability of the vehicle receiving the fuel.
